(19) United States
(12) Patent Application Publication
(10) Pub. No.: US 2026/0031297 A1
(43) Pub. Date: Jan. 29, 2026

(54) SLOW-WAVE STRUCTURE, TRAVELING-WAVE TUBE, AND COMMUNICATION APPARATUS

(71) Applicant: HUAWEI TECHNOLOGIES CO., LTD., Shenzhen,Guangdong (CN)

(72) Inventors: Xin Wang, Chengdu (CN); Hua Cai, Chengdu (CN); Qianfu Cheng, Chengdu (CN); Jie Xie, Shenzhen (CN); Guangjian Wang, Chengdu (CN)

(21) Appl. No.: 19/343,522

(22) Filed: Sep. 29, 2025

Related U.S. Application Data
(63) Continuation of application No. PCT/CN2023/085046, filed on Mar. 30, 2023.

(51) Int. Cl. H01J 23/26; H01J 25/36

(52) U.S. Cl. CPC H01J 23/26; H01J 25/36

(57) ABSTRACT

A slow-wave structure, a traveling-wave tube, and a communication apparatus are provided. The slow-wave structure includes a tube housing, a slow-wave line, and a plurality of support portions. The slow-wave line and the plurality of support portions are all located inside the tube housing, and the tube housing, the slow-wave line, and the plurality of support portions are integrally connected. The plurality of support portions are sequentially spaced apart along the slow-wave line. One end of each support portion is connected to the tube housing, and the other end is connected to the slow-wave line.

### CROSS-REFERENCE TO RELATED APPLICATIONS

This application is a continuation of International Application No. PCT/CN2023/085046, filed on Mar. 30, 2023, the disclosure of which is hereby incorporated by reference in its entirety.

### TECHNICAL FIELD

This application relates to the field of communication devices, and in particular, to a slow-wave structure, a traveling-wave tube, and a communication apparatus.

### BACKGROUND

As traveling-wave tube (traveling-wave tube, TWT), widely utilized as a power amplifier in the current millimeter-wave bands, integrates advantages of wide operating bands, large output power, high efficiency, and compact dimensions, presenting vast potential for applications in the field of millimeter-wave communication. A core component of the traveling-wave tube is a slow-wave structure. However, the assembly of conventional slow-wave structures tends to be intricate, leading to an extended production cycles, low yields, and inconsistency across devices.

### SUMMARY

Technical solutions of this application provide a slow-wave structure, a traveling-wave tube, and a communication apparatus, to simplify assembly of the slow-wave structure, thereby shortening an overall production cycle of the traveling-wave tube, and improving yields and consistency of the traveling-wave tube.

According to a first aspect, a technical solution of this application provides a slow-wave structure, including a tube housing, a slow-wave line, and a plurality of support portions. The slow-wave line and the plurality of support portions are all located inside the tube housing, and the tube housing, the slow-wave line, and the plurality of support portions are integrally connected. The plurality of support portions are sequentially spaced apart along the slow-wave line. One end of each support portion is connected to the tube housing, and the other end is connected to the slow-wave line.

In this solution, the tube housing, the slow-wave line, and the support portion in the slow-wave structure are made into an integrated structure, so that processing and assembly errors caused by a split design of a conventional slow-wave structure can be improved, and an entire tube assembly process can be simplified, thereby shortening an overall production cycle of a traveling-wave tube, and improving a yield and consistency of the traveling-wave tube. The slow-wave line is suspended in the tube housing by using the plurality of support portions, so that a new slow-wave structure can be provided, to meet a product requirement.

In an implementation of the first aspect, the tube housing includes a tube housing body and a plurality of tube housing protruding portions, the plurality of tube housing protruding portions are all connected to the tube housing body, the plurality of tube housing protruding portions project from the tube housing body, and the plurality of tube housing protruding portions are sequentially spaced apart along the tube housing body. The slow-wave line is located inside the tube housing body. One part of each support portion is accommodated in the tube housing body, and the other part of each support portion is accommodated in the tube housing protruding portion.

In this solution, the tube housing is disposed as the tube housing body and the tube housing protruding portion, and the support portion is located inside the tube housing body and the tube housing protruding portion, so that a product design requirement of a slow-wave structure having a relatively large volume can be met. In addition, the support portion is made relatively long, so that support strength of the support portion can be increased.

In an implementation of the first aspect, a lengthwise direction of at least one support portion is perpendicular to a lengthwise direction of the slow-wave line. The lengthwise direction of the support portion is made perpendicular to the lengthwise direction of the slow-wave line, so that the slow-wave structure is a compact structure and has relatively high structural strength. This also facilitates product miniaturization.

In an implementation of the first aspect, a non-90-degree included angle is formed between a lengthwise direction of at least one support portion and a lengthwise direction of the slow-wave line. The support portion is made inclined relative to the slow-wave line, so that the support portion can have an enough length in limited size space, to help ensure support strength of the support portion.

In an implementation of the first aspect, at least a part of the plurality of support portions are sequentially connected to form a wavy-line structure. The support portions are connected and form the wavy-line structure, so that structural strength and support strength can be increased.

In an implementation of the first aspect, the plurality of support portions are distributed on two sides of the slow-wave line. The support portions are distributed on the two opposite sides of the slow-wave line, to help ensure structural strength and support strength.

In an implementation of the first aspect, a length L of each support portion and a guided-wave wavelength λ of the slow-wave structure satisfy the following relationship formula:

$$L = \frac{n λ}{4} * ( 1 \pm 10 \% ) ,$$

where n is an odd number. The length of the support portion is made satisfy the foregoing relationship formula, so that a product requirement can be met. Especially, when the support portion is made of a conductive material, this helps make apparent impedance of a high-frequency electromagnetic wave from the slow-wave line to the tube housing in an open circuit through impedance matching, so that the support portion does not affect signal transmission in an operating band.

In an implementation of the first aspect, the tube housing, the slow-wave line, and the plurality of support portions are made of a same material. The same material is used, to help manufacture an integrated slow-wave structure by using a planarization process, so that assembly of the slow-wave structure can be simplified, thereby shortening an overall production cycle of a traveling-wave tube, and improving a yield and consistency of the traveling-wave tube.

In an implementation of the first aspect, each support portion includes an inner layer and an outer layer, the outer layer is wrapped around an outer periphery of the inner layer, the inner layer is made of an insulating material, and the outer layer is made of a same material as the tube housing and the slow-wave line. A material of the outer layer of the support portion is made the same as materials of the tube housing and the slow-wave line, to help manufacture the slow-wave structure by using a 3D printing process, so that assembly of the slow-wave structure can be simplified, thereby shortening an overall production cycle of a traveling-wave tube, and improving a yield and consistency of the traveling-wave tube.

In an implementation of the first aspect, the slow-wave structure further includes an attenuator, the slow-wave line includes a plurality of disconnected segments, and each of the plurality of segments is connected to the attenuator. The slow-wave line is segmented and the attenuator is disposed, so that a reflected electromagnetic wave can be absorbed, to avoid parasitic oscillation of a traveling-wave tube, and improve a gain and stability of the traveling-wave tube.

In an implementation of the first aspect, the slow-wave line is a folding line, the folding line includes a plurality of bending units sequentially connected end to end, and all the bending units are coplanar. The foregoing integrated design is applied to the slow-wave structure having the folding line, so that assembly of the slow-wave structure can be simplified.

In an implementation of the first aspect, the plurality of support portions are coplanar with the slow-wave line. The support portion is made coplanar with the slow-wave line, to help manufacture the slow-wave structure by using a planarization process, so that assembly of the slow-wave structure can be simplified, thereby shortening an overall production cycle of a traveling-wave tube, and improving a yield and consistency of the traveling-wave tube.

In an implementation of the first aspect, the slow-wave structure includes two layers of support portions between which a gap is defined, and each layer of support portions includes a plurality of support portions. The slow-wave structure includes two layers of slow-wave lines between which a gap is defined, and one layer of slow-wave line is correspondingly connected to one layer of support portions. The slow-wave structure having the two layers of slow-wave lines has a relatively strong electromagnetic wave field, a relatively strong interaction, relatively high efficiency, and a relatively high gain. The foregoing integrated design is applied to the slow-wave structure having the two layers of slow-wave lines, so that assembly of the slow-wave structure can be simplified.

In an implementation of the first aspect, the slow-wave line has a helical structure. The foregoing integrated design is applied to the slow-wave structure having a helix, so that assembly of the slow-wave structure can be simplified.

According to a second aspect, a technical solution of this application provides a traveling-wave tube, including an electron gun, a focusing system, a collector, an input apparatus, an output apparatus, and the slow-wave structure according to any one of the foregoing implementations. The electron gun, the focusing system, the collector, the input apparatus, and the output apparatus are all connected to the slow-wave structure.

The slow-wave structure in this solution is an integrated structure, and assembly of the slow-wave structure is relatively simple, so that an overall production cycle of the traveling-wave tube is relatively short, and a yield and consistency of the traveling-wave tube are relatively high.

In an implementation of the second aspect, the input apparatus includes a mode converter and/or the output apparatus includes a mode converter, the mode converter is connected to the slow-wave line, and the mode converter is configured to implement conversion between an operating mode of the slow-wave structure and an operating mode of an external circuit. The mode converter is disposed, so that matching between the slow-wave structure and the external circuit can be implemented.

In an implementation of the second aspect, the slow-wave structure includes two layers of slow-wave lines. The mode converter includes a flat waveguide, a conductive plate, a ridge, and a coupled strip line. The conductive plate is disposed inside an inner cavity of the flat waveguide, and there is a gap between each of plate surfaces on two opposite sides of the conductive plate and a cavity wall of the inner cavity. The ridge is disposed on the plate surface, and the ridge is not connected to the cavity wall of the inner cavity. An inner conductor of the coupled strip line includes a first part and a second part, the first part is connected to the ridge and the second part, and an end that is of the second part and that faces away from the first part is connected to the two layers of slow-wave lines. A width of the first part is greater than a width of the second part, and the width of the first part declines along a direction from the first part to the second part.

In this solution, for the slow-wave structure having two layers of folding lines, the foregoing mode converter is designed, so that conversion between a mode of an external circuit and a mode of the slow-wave structure can be implemented, to implement good matching between the slow-wave structure and the external circuit.

In an implementation of the second aspect, the slow-wave structure includes two layers of slow-wave lines. The mode converter includes a flat waveguide, a ridge, and a coupled strip line. The ridge is disposed inside an inner cavity of the flat waveguide, the ridge includes a first surface and a second surface, the first surface is opposite to the second surface, a spacing between the first surface and the second surface declines from one end of the ridge to the other opposite end, there is a gap between the first surface and an inner wall of the inner cavity, and the second surface is connected to the inner wall of the inner cavity. An inner conductor of the coupled strip line is connected to the ridge and the two layers of slow-wave lines.

In this solution, for the slow-wave structure having two layers of folding lines, the foregoing mode converter is designed, so that conversion between a mode of an external circuit and a mode of the slow-wave structure can be implemented, to implement good matching between the slow-wave structure and the external circuit. The mode converter in this solution has a relatively simple structure, so that a product requirement can be met.

In an implementation of the second aspect, the first surface has a plurality of sequentially connected steps, and heights of the plurality of steps sequentially decrease. The first surface of the ridge is designed as a step structure, so that a bidirectional mode conversion role and an impedance matching role of the ridge can be implemented, to meet a product requirement.

In an implementation of the second aspect, the mode converter includes a tapered waveguide and a standard rectangular waveguide, the tapered waveguide is connected to the flat waveguide and the standard rectangular waveguide, and the coupled strip line and the standard rectangular waveguide are respectively located at two opposite ends of the flat waveguide. The tapered waveguide and the standard rectangular waveguide are designed, so that the mode converter can implement conversion between a standard waveguide mode of an external circuit and a mode of the slow-wave structure.

According to a third aspect, a technical solution of this application provides a communication apparatus, including the traveling-wave tube according to any one of the foregoing implementations. The slow-wave structure in this solution is an integrated structure, and assembly of the slow-wave structure is relatively simple, to help shorten an overall production cycle of the communication apparatus, and improve a yield and consistency.

In an implementation of the third aspect, the communication apparatus is a network device, a terminal device, a vehicle-mounted device, or a satellite payload. This solution can be applied to a scenario such as a network device, a terminal device, a vehicle-mounted device, or a satellite payload, to meet a design requirement.

### BRIEF DESCRIPTION OF DRAWINGS

FIG. 1 is a diagram of a framework structure of a traveling-wave tube in an embodiment of this application;

FIG. 2 is a diagram of an external structure of a slow-wave structure in Embodiment 1;

FIG. 3 is a diagram of internal and external structures of a slow-wave structure in Embodiment 1;

FIG. 4 is a diagram of structures of a slow-wave line and a support portion of a slow-wave structure in Embodiment 1;

FIG. 5 shows a transmission characteristic plot of a slow-wave structure in Embodiment 1;

FIG. 6 shows a beam-wave interaction simulation result of a slow-wave structure in Embodiment 1;

FIG. 7 shows another beam-wave interaction simulation result of a slow-wave structure in Embodiment 1;

FIG. 8 is a diagram of internal and external structures of a mode converter in Implementation 1 of Embodiment 1;

FIG. 9 is an A-A sectional view of the mode converter shown in FIG. 8;

FIG. 10 is a diagram of a partial structure of the mode converter shown in FIG. 8;

FIG. 11 is a view of the structure shown in FIG. 10 in a direction B;

FIG. 12 shows a simulation result of transmission performance of a traveling-wave tube with a mode converter used;

FIG. 13 is a diagram of internal and external structures of a mode converter in Implementation 2 of Embodiment 1;

FIG. 14 is a diagram of a side-view structure of a ridge of a mode converter in another implementation of Embodiment 1;

FIG. 15 is a diagram of an external structure of a slow-wave structure in Embodiment 2;

FIG. 16 is a diagram of internal and external structures of a slow-wave structure in Embodiment 2;

FIG. 17 is a diagram of internal and external structures of a slow-wave structure in Embodiment 3;

FIG. 18 is a diagram of structures of a slow-wave line and a support portion of a slow-wave structure in Embodiment 3;

FIG. 19 is a diagram of an external structure of a slow-wave structure in Embodiment 4;

FIG. 20 is a diagram of internal and external structures of a slow-wave structure in Embodiment 4;

FIG. 21 is a diagram of structures of a slow-wave line and a support portion of a slow-wave structure in Embodiment 4;

FIG. 22 is a schematic typographic of a slow-wave structure in an embodiment of this application;

FIG. 23 shows a schematic layered slice of a slow-wave structure in an embodiment of this application;

FIG. 24 is a diagram of performing region allocation on a substrate;

FIG. 25 is a diagram of a slow-wave structure array electroplated on a copper wafer; and

FIG. 26 is a diagram in which slow-wave structure units manufactured by using a planarization process are assembled with a peripheral tube housing into a slow-wave structure having two layers of folding lines.

### DESCRIPTION OF EMBODIMENTS

In embodiments of this application, the terms such as “first”, “second”, and “third” are merely used to distinguish with components, and cannot be understood as an indication or implication of relative importance of the components or an implication of a quantity of indicated technical features. Therefore, a feature limited by “first”, “second”, or the like may explicitly or implicitly include one or more such features.

In descriptions of embodiments of this application, unless otherwise specified, “a plurality of (layers)” means two (layers) or more (layers).

In embodiments of this application, the terms such as “on”, “under”, “front”, “front side”, “back”, and “back side” are defined with respect to a schematic placement position of a structure in the accompanying drawings. It should be understood that these directional terms are relative concepts, are relative descriptions and clarifications, and may accordingly change based on a change of the placement position of the structure.

In embodiments of this application, unless otherwise specified, “and/or” describes only an association relationship between associated objects and indicates that three relationships may exist. For example, A and/or B may indicate the following three cases: Only A exists, both A and B exist, and only B exists.

The following embodiment of this application provides a communication apparatus. The communication apparatus is applicable to both a low-frequency scenario (sub 6G) and a high-frequency scenario (above 6G). An application scenario includes but is not limited to a long term evolution (Long Term Evolution, LTE) system, a 5th generation system, a new radio (new radio, NR) communication system, a future evolved public land mobile network (public land mobile network, PLMN) system, or the like. The communication apparatus includes but is not limited to a network device, a terminal device, a vehicle-mounted device, a satellite payload, or the like.

The network device includes but is not limited to a next generation NodeB (gNodeB, gNB) in a 5G, an evolved NodeB (evolved NodeB, eNB) in a long term evolution (long term evolution, LTE) system, a radio network controller (radio network controller, RNC), a radio controller in a cloud radio access network (cloud radio access network, CRAN) system, a base station controller (base station controller, BSC), a home base station (for example, a home evolved NodeB or a home NodeB, HNB), a baseband unit (baseBand unit, BBU), a transmitting and receiving point (transmitting and receiving point, TRP), a transmitting point (transmitting point, TP), a mobile switching center, or a base transceiver station (base transceiver station, BTS) in a global system for mobile communication (global system for mobile communication, GSM) or code division multiple access (code division multiple access, CDMA) network. Alternatively, the network device may be a node base station (node base station, NB) in wideband code division multiple access (wideband code division multiple access, WCDMA), may be an evolved (evolved) NB (eNB or eNodeB) in LTE, may be a base station device in a future 5G network or an access network device in a future evolved PLMN network, may be a wearable device or a vehicle-mounted device, or may be a radio frequency base station, a microwave base station, a millimeter-wave base station, a terahertz base station, or the like.

When the network device is an access network device, the network device may be further connected to a core network (core network, CN) device. The access network device is a device that provides a network access function, for example, a radio access network (radio access network, RAN) base station. The network device may specifically include a base station (base station, BS) (such as a RAN base station), or include a base station and a radio resource management device configured to control the base station, or the like. The network device may alternatively include a relay station (relay device), an access point, a base station in a future 5G network, a base station in a future evolved PLMN network, an NR base station, or the like. The network device may be a wearable device or a vehicle-mounted device. The network device may alternatively be a communication chip having a communication module.

The terminal device may be user equipment (user equipment, UE), a terminal (terminal), an access terminal, a terminal unit, a terminal station, a mobile station (mobile station, MS), a remote station, a remote terminal, a mobile terminal (mobile terminal), a wireless communication device, a terminal agent, or the like. The terminal device may have a wireless transceiver function, and can communicate (for example, perform wireless communication) with one or more network devices in one or more communication systems, and accept network services provided by the network devices. The terminal device may be a cellular phone, a cordless phone, a session initiation protocol (session initiation protocol, SIP) phone, a wireless local loop (wireless local loop, WLL) station, a personal digital assistant (personal digital assistant, PDA) device, a handheld device having a wireless communication function, a computing device, another processing device connected to a wireless modem, a vehicle-mounted device, a wearable device, a terminal apparatus in a future 5G network, a terminal apparatus in a future evolved PLMN network, or the like.

The terminal device may be deployed on land, including indoor or outdoor, handheld, or vehicle-mounted devices, the terminal device may be deployed on water (for example, on a steamship), or the terminal device may be deployed in the air (for example, on an airplane, a balloon, or a satellite). The terminal device may be specifically a mobile phone (mobile phone), a tablet computer (pad), a computer with a wireless transceiver function, a display, a virtual reality (virtual reality, VR) terminal, an augmented reality (augmented reality, AR) terminal, a wearable device (such as a smart watch or a smart band), a smart screen device, a headset (such as a wired headset or a wireless headset), a router, portable Wifi, a mobile power supply, an e-reader, a mouse, a smart speaker, a printer, a smart door lock, a home storage, a wireless terminal in industrial control (industrial control), a wireless terminal in self driving (self driving), a wireless terminal in telemedicine (remote medical), a wireless terminal in a smart grid (smart grid), a wireless terminal in transportation safety (transportation safety), a wireless terminal in a smart city (smart city), a wireless terminal in a smart home (smart home), or the like. The terminal device may alternatively be a communication chip having a communication module, or may be a vehicle having a communication function, a vehicle-mounted device (for example, a vehicle-mounted communication apparatus or a vehicle-mounted communication chip), or the like.

The vehicle-mounted device includes but is not limited to a millimeter-wave radar, a terahertz imaging device, or the like.

The satellite payload is an instrument, a device, or a system that is carried on a satellite to perform a specific task. The satellite includes but is not limited to a communication satellite, a meteorological satellite, or the like.

A traveling-wave tube is used in the communication apparatus in embodiments of this application. As an electric vacuum power amplification device, the traveling-wave tube has comprehensive advantages of a wide operating band, large output power, high efficiency, and a small volume, and has a broad application prospect in the field of millimeter-wave communication. For example, in an application scenario of a millimeter-wave base station, equivalent isotropically radiated power (equivalent isotropically radiated power, EIRP) of the base station can be greatly improved by using a millimeter-wave traveling-wave tube, thereby reducing a quantity of base stations and decreasing deployment costs.

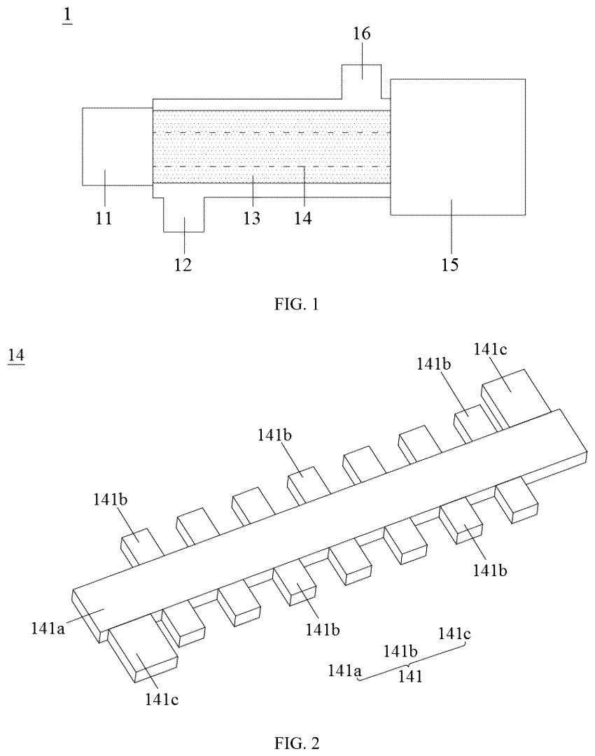

FIG. 1 shows a schematic structure of a traveling-wave tube in an embodiment of this application. As shown in FIG. 1, a traveling-wave tube 1 may include a slow-wave structure 14 (a part between two dashed lines), an electron gun 11, a collector 15, a focusing system 13 (a dotted shadow region), an input apparatus 12, and an output apparatus 16. The slow-wave structure 14 may include a tube housing and a slow-wave line suspended in the tube housing (which are further described below).

The electron gun 11 and the collector 15 may be respectively connected to two opposite ends of the slow-wave structure 14. As shown in FIG. 1, for example, the focusing system 13 may surround an outer periphery of the tube housing of the slow-wave structure 14. In another implementation, the focusing system 13 may alternatively be distributed on two sides of the tube housing of the slow-wave structure 14. The input apparatus 12 and the output apparatus 16 are respectively connected to two ends of the slow-wave structure 14. The input apparatus 12 and the output apparatus 16 may accommodate the slow-wave structure 14, to provide a vacuum operating environment for the slow-wave structure 14. Both the input apparatus 12 and the output apparatus 16 are connected to the slow-wave line.

Referring to FIG. 1, an operating principle of the traveling-wave tube 1 is as follows: The electron gun 11 generates an electron beam, and accelerates the electron beam to a speed slightly higher than a speed of an electromagnetic wave traveling on the slow-wave line. The electron beam emitted by the electron gun 11 can enter the slow-wave structure 14 and be transmitted along the slow-wave line. The focusing system 13 can keep the electron beam in a required shape, to ensure that the electron beam smoothly passes through the slow-wave structure 14 and effectively interacts with an electromagnetic field. The focusing system 13 may be, for example, a magnetic focusing system, and restricts the electron beam by using a magnetic field. The input apparatus 12 may be connected to an external circuit, and the input apparatus 12 may input a to-be-amplified signal of the external circuit to the slow-wave structure 14. The input apparatus 12 may further perform mode conversion on the to-be-amplified signal, for example, convert a waveguide mode of the to-be-amplified signal into a transverse electromagnetic mode (transverse electromagnetic mode, TEM) or a quasi-TEM mode, so that an operating mode of the slow-wave structure 14 matches a mode of an external signal. The slow-wave structure 14 is a core component of the traveling-wave tube 1, and can enable the electron beam to fully interact with the to-be-amplified signal, and convert kinetic energy of an electron into electromagnetic wave energy, thereby implementing signal amplification. When the electron beam interacts with the electromagnetic wave, the electron beam is also modulated by the electromagnetic wave. An amplified signal may be transmitted to the output apparatus 16 through the slow-wave line, and coupled to an external circuit by using the output apparatus 16. The output apparatus 16 may perform mode conversion on the amplified signal, for example, convert a TEM mode or a quasi-TEM mode of the amplified signal into a waveguide mode, so that an output signal of the traveling-wave tube 1 matches a mode of an external signal. The collector 15 is configured to collect an electron beam remaining after an interaction with the slow-wave structure 14 is completed.

Most components or all components of the slow-wave structure 14 in embodiments of this application are integrally connected. To be specific, most components or all components of the slow-wave structure 14 may be manufactured in a same process (a planarization process such as a semiconductor process or a 3D printing process that is to be described below) and form an integrated structure. The following provides detailed descriptions.

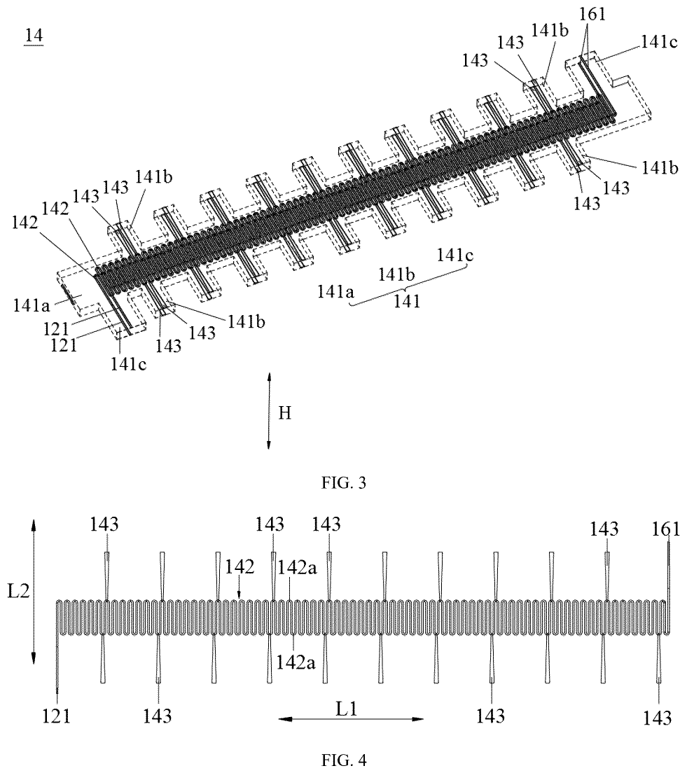

FIG. 2 and FIG. 3 show schematic structures of a slow-wave structure 14 in Embodiment 1. FIG. 2 is a diagram of an external structure of the slow-wave structure 14, and FIG. 3 is a diagram of an internal and external structure of the slow-wave structure 14.

As shown in FIG. 2 and FIG. 3, the slow-wave structure 14 may include a tube housing 141, two layers of slow-wave lines 142, and a plurality of support portions 143. The tube housing 141, the two layers of slow-wave lines 142, and the plurality of support portions 143 are integrally connected. The tube housing 141 has a cavity inside, and the two layers of slow-wave lines 142 and the plurality of support portions 143 are all accommodated in the cavity of the tube housing 141.

In embodiments, the tube housing 141 may be of an integrated structure, and the integrated tube housing 141 may be manufactured by using the planarization process. Alternatively, the tube housing 141 may be formed by assembling a plurality of sub housings. The tube housing 141 is generally of a discrete structure, but at least one sub housing may be of an integrated structure manufactured by using the planarization process. It may be understood that, for the tube housing 141 of the generally discrete structure, the slow-wave line 142 and the support portion 143 may be integrally connected to the sub housings in the split tube housing 141. This may also described as that the tube housing 141, the slow-wave line 142, and the support portion 143 are still integrally connected.

As shown in FIG. 2 and FIG. 3, the tube housing 141 may include a tube housing body 141a, a plurality of tube housing protruding portions 141b, and two tube housing protruding portions 141c. The tube housing body 141a may be, for example, in a shape of a long rectangular box. The tube housing protruding portion 141b and the tube housing protruding portion 141c may be, for example, in shapes of short rectangular boxes. Both the tube housing protruding portion 141b and the tube housing protruding portion 141c are connected to an outer side of the tube housing body 141a, and are protruding relative to a surface of the tube housing body 141a. A plurality of tube housing protruding portions 141b may be arranged on each of two opposite sides of the tube housing body 141a (for example, two sides on which two opposite long sides of the tube housing body 141a are located). There is a specific spacing between two adjacent tube housing protruding portions 141b. Spacings between any two adjacent tube housing protruding portions 141b may be basically equal or equal. The two tube housing protruding portions 141c may be respectively located at two opposite ends of the tube housing body 141a. For example, the two tube housing protruding portions 141c may be respectively located at the two opposite sides of the tube housing body 141a. The tube housing body 141a, the tube housing protruding portion 141b, and the tube housing protruding portion 141c are all hollow, and the three parts jointly enclose an inner cavity of the tube housing 141. It may be understood that the foregoing appearance structure of the tube housing 141 is merely an example. Actually, an appearance structure of the tube housing 141 may be designed based on a requirement.

As shown in FIG. 3, the two layers of slow-wave lines 142 may be suspended in the tube housing body 141a, and the two layers of slow-wave lines 142 are not in contact with an inner wall of the tube housing body 141a. As shown in FIG. 3 and FIG. 4, the two layers of slow-wave lines 142 may be stacked in a thickness direction H in FIG. 3, and there may be a gap between the two layers of slow-wave lines 142. Structures of the two layers of slow-wave lines 142 may be consistent or approximately consistent, and the two layers of slow-wave lines 142 may overlap or approximately overlap when being projected in the thickness direction H.

As shown in FIG. 4, the slow-wave line 142 may be a folding line, and the slow-wave line 142 includes a plurality of bending units 142a sequentially connected end to end. The bending unit 142a may be, for example, approximately “n”-shaped or “u”-shaped. In some implementations, the bending unit 142a may alternatively be in another proper shape, for example, “v”-shaped or “s”-shaped. Parts of each bending unit 142a may be on one plane, and all the bending units 142a may also be coplanar, so that the slow-wave line 142 is distributed on one plane. A quantity of bending units 142a may be designed based on a requirement. For example, the quantity of bending units 142a may be 75, or a quantity of cycles of the slow-wave line 142 is 75.

As shown in FIG. 4, the slow-wave line 142 may be generally strip-shaped, and a lengthwise direction L1 of the strip-shaped slow-wave line 142 may be defined, that is, an overall extension direction of the slow-wave line 142 from one end (for example, the left end in FIG. 4) to the other end (for example, the right end in FIG. 4). Illustratively, the lengthwise direction L1 may be the horizontal direction in FIG. 4.

FIG. 3 and FIG. 4 further show two input lines 121 in the input apparatus 12 and two output lines 161 in the output apparatus 16. The two input lines 121 and the two output lines 161 may be respectively connected to two ends of the lengthwise direction L1 of the slow-wave line 142. One input line 121 is correspondingly connected to one layer of slow-wave line 142, and one output line 161 is correspondingly connected to one layer of slow-wave line 142. Structures and types of the input line 121 and the output line 161 are not limited. For example, the input line 121 and the output line 161 each may be an inner conductor in a coupled strip line. The input apparatus 12 may input a to-be-amplified signal to the slow-wave line 142 through the input line 121. The output apparatus 16 may output an amplified signal through the output line 161. The input line 121 and the output line 161 may respectively extend into the two tube housing protruding portions 141c.

As shown in FIG. 3 and FIG. 4, all the support portions 143 may also be divided into two layers spaced apart. The two layers may be stacked in the thickness direction H in FIG. 3, and the two layers of support portions 143 may overlap or approximately overlap when being projected in the thickness direction H. There is a gap between two corresponding support portions 143 in the two layers. In each layer, support portions 143 may be coplanar with or approximately coplanar with a slow-wave line 142, the support portions 143 may be sequentially spaced apart in a lengthwise direction L1 of the slow-wave line 142, and a plurality of support portions 143 may be distributed on each of two sides of the slow-wave line 142. A quantity and a spacing of support portions 143 may be designed based on a product requirement. For example, adjacent support portions 143 may be spaced apart by seven bending units 142a, or may be spaced apart by seven cycles of the slow-wave line 142.

As shown in FIG. 4, the support portion 143 may be approximately strip-shaped or rod-shaped (for example, the support portion 143 may be referred to as a stub), and a lengthwise direction L2 of the support portion 143 may be defined. For example, the lengthwise direction L2 may be a vertical direction in FIG. 4, and the lengthwise direction L2 may be perpendicular or approximately perpendicular to the lengthwise direction L1 of the slow-wave line 142. For example, lengths (sizes in the lengthwise direction L2) of all the support portions 143 may be consistent or approximately consistent.

As shown in FIG. 4 and FIG. 3, a part of the support portion 143 may be located inside the tube housing body 141a, the other part of the support portion 143 may be located inside the tube housing protruding portion 141b, and the support portion 143 is connected between an inner wall of the tube housing protruding portion 141b and the slow-wave line 142. The support portion 143 can play a role of supporting the slow-wave line 142. Therefore, the slow-wave line 142 can be suspended in the tube housing 141 by using the support portion 143. The support portion 143 is distributed in the tube housing body 141a and the tube housing protruding portion 141b, so that a length of the support portion 143 can meet a product requirement, and support strength can also be increased.

In this embodiment, the support portion 143, the slow-wave line 142, and the tube housing 141 may be made of a same type of conductive material. Materials of all parts of the support portion 143 are the conductive material. The conductive material may be metal, for example, molybdenum alloy, tungsten alloy, tungsten, molybdenum, copper, stainless steel, or nickel-based alloy, or the conductive material may be non-metal. The same type of conductive material is used, to help manufacture the slow-wave structure 14 in batches by using the planarization process.

In another embodiment, the support portion 143 may include an inner layer and an outer layer, the outer layer covers an outer side of the inner layer, and the outer layer wraps all regions of the inner layer. The inner layer may be made of an insulating material. Materials of the outer layer, the slow-wave line 142, and the tube housing 141 may be a same type of conductive material. The slow-wave structure in this embodiment may be manufactured by using, for example, a 3D printing process.

In another embodiment, materials of the support portion 143, the slow-wave line 142, and the tube housing 141 may not be completely the same. The support portion 143 may be made of a conductive material or an insulating material, and the slow-wave line 142 and the tube housing 141 may be made of a conductive material.

In this embodiment, the support portion 143 may be made of a conductive material, and the length L of the support portion 143 and a guided-wave wavelength λ of the slow-wave structure 14 may satisfy the following relationship formula:

$$L = \frac{n λ}{4} * ( 1 \pm 10 \% ) ,$$

where n is an odd number. It may be understood that n is a positive number. For example, n may be 1, 3, or 5. 10% in the relationship formula represents an error range. For example, the length L of the support portion 143 may be

$$\frac{n λ}{4} * 90 \% , \frac{n λ}{4} * 95 \% , \frac{n λ}{4} , \frac{n λ}{4} * 1 \; 04 \% , or \frac{n λ}{4} * 110 \% .$$

Because the support portion 143 is connected to the slow-wave line 142 and the tube housing 141, from a perspective of a direct current, the support portion 143 directly grounds the slow-wave line 142 (the tube housing 141 is used as a ground). The foregoing length design is performed on the support portion 143, to help make apparent impedance of a high-frequency electromagnetic wave from the slow-wave line 142 to the tube housing 141 in an open circuit through impedance matching, so that the support portion 143 does not affect signal transmission in an operating band.

In another embodiment, at least a part of the support portion 143 may be made of an insulating material. For example, the inner layer of the support portion 143 is made of an insulating material, and the outer layer is made of a conductive material; or all parts of the support portion 143 are made of an insulating material. In these solutions, the length of the support portion 143 may still be made satisfy

$$L = \frac{n λ}{4} * ( 1 \pm 10 \% ) ,$$

to meet a product requirement.

In this embodiment, the quantity and the spacing of support portions 143 are properly designed, so that good transmission performance of a signal in a target band can be met. In addition, the support portion 143 may further play a heat conduction role, so that the quantity and the spacing of support portions 143 can be designed based on a requirement, to meet a heat dissipation requirement of the traveling-wave tube 1.

The slow-wave structure 14 in this embodiment has two layers of folding lines, in other words, the slow-wave structure 14 is based on a coupled strip line. Therefore, a fundamental mode (mode 1) and an even mode (mode 2) exist. An operating mode of the slow-wave structure 14 is the even mode. The slow-wave structure 14 has an electric field in a longitudinal direction (a transmission direction of an electron beam), and the electric field can interact with the electron beam, to amplify an electromagnetic wave signal.

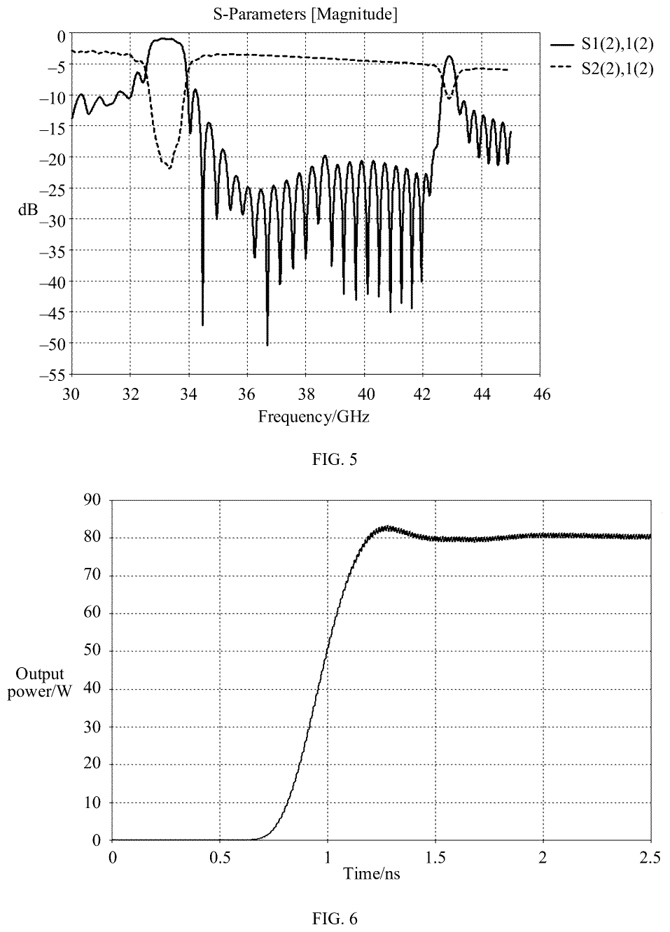

FIG. 5 shows a transmission characteristic plot of the slow-wave structure 14 in this embodiment. As shown in FIG. 5, in a frequency range of 34 GHz to 42 GHz, in the mode 2, a reflection coefficient S11 is less than −20 dB, and a transmission coefficient S21 is about −5 dB. This indicates that a transmission characteristic of the slow-wave structure 14 is relatively good. A bandwidth of about 8 GHz can completely meet a requirement of the traveling-wave tube 1 in this band. It is proved, from a perspective of simulation, that the structure in which the slow-wave line 142 is supported by using the support portion 143 can completely replace a conventional structure in which a slow-wave line is supported by using a ceramic medium.

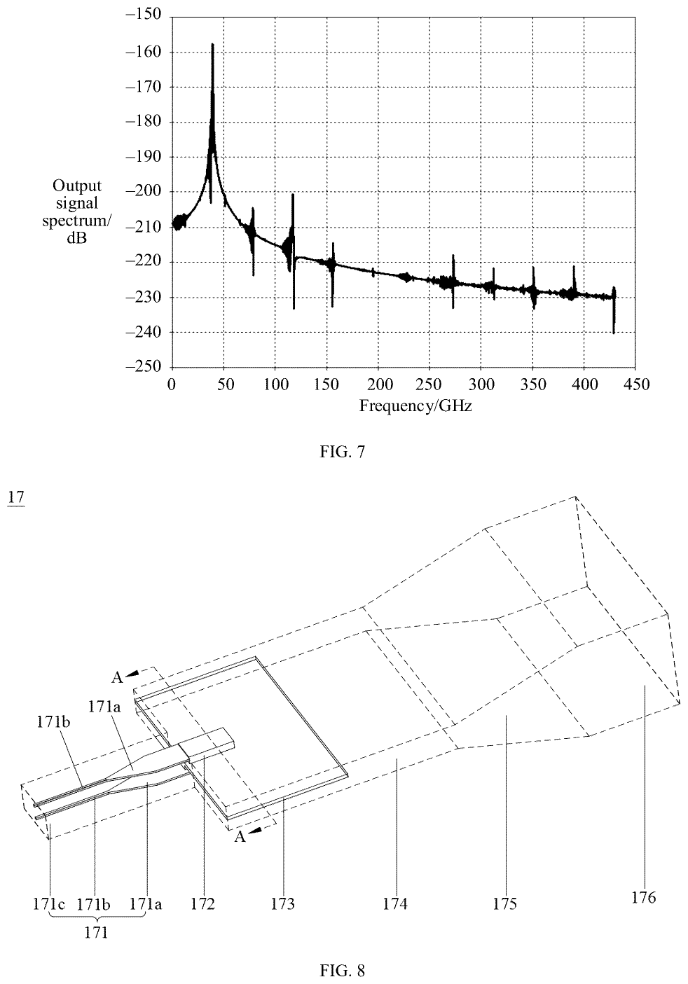

Through beam-wave interaction simulation, under a condition that input power is 31 mW, beam-wave interaction simulation results of the slow-wave structure 14 that are shown in FIG. 6 and FIG. 7 may be obtained. FIG. 6 shows power of an output signal, and FIG. 7 shows a spectrum corresponding to the output signal. As shown in FIG. 6 and FIG. 7, output power is 80 W@40 GHz, a corresponding gain is 34 dB, electronic efficiency is 12.9%, an output signal spectrum is pure, and there is no definite clutter signal in an operating band. This also proves, from the perspective of simulation, that the traveling-wave tube 1 having the slow-wave structure 14 has a signal amplification function.

In the slow-wave structure 14 in this embodiment, impact of the support portion 143 on a dispersion characteristic can suppress a synchronization condition under which backward wave oscillation and reflective oscillation are generated. The support portion 143 plays a jump role on a phase velocity of the slow-wave structure 14. Therefore, it is difficult to stimulate backward wave oscillation, thereby improving a gain of a single-segment slow-wave structure. For example, the simulation results show that the gain of the single-segment slow-wave structure can reach 34 dB. This is significantly higher than a theoretical value that is of a single-segment gain of a conventional slow-wave structure and that does not exceed 25 dB. In addition, because the support portion 143 has an oscillation suppression effect, a problem that a cutoff and an attenuator need to be additionally added to a conventional high-gain traveling-wave tube for stability can be resolved, thereby simplifying a structure and a process of the high-gain traveling-wave tube.

The conventional slow-wave structure using an all-metal waveguide structure operates in a waveguide mode, and has a relatively large structure size. However, the operating mode of the slow-wave structure 14 in this embodiment may be a non-waveguide mode, for example, a TEM mode or a quasi-TEM mode, so that the slow-wave structure 14 and the traveling-wave tube 1 can have relatively small structure sizes, and can meet a miniaturization application requirement of a communication apparatus.

In this embodiment, at least one slow-wave line 142 may alternatively be disposed as a plurality of disconnected segments, an attenuator connected to the slow-wave line 142 is disposed, and each of the plurality of segments is connected to the attenuator. For example, two adjacent segments may be connected by using a same attenuator, or the segments are separately connected to different attenuators. The attenuator is configured to absorb a reflected electromagnetic wave, to avoid parasitic oscillation of the traveling-wave tube 1. The solution of segmenting the slow-wave line 142 can improve a gain and stability of the traveling-wave tube 1.

In this embodiment, to match a waveguide mode, for example, a transverse electric mode (transverse electric mode, TE) or a quasi-TE mode, of an external circuit, a special mode converter may be designed in the input apparatus 12 and/or a special mode converter may be designed in the output apparatus 16, to implement mode conversion. The following provides descriptions.

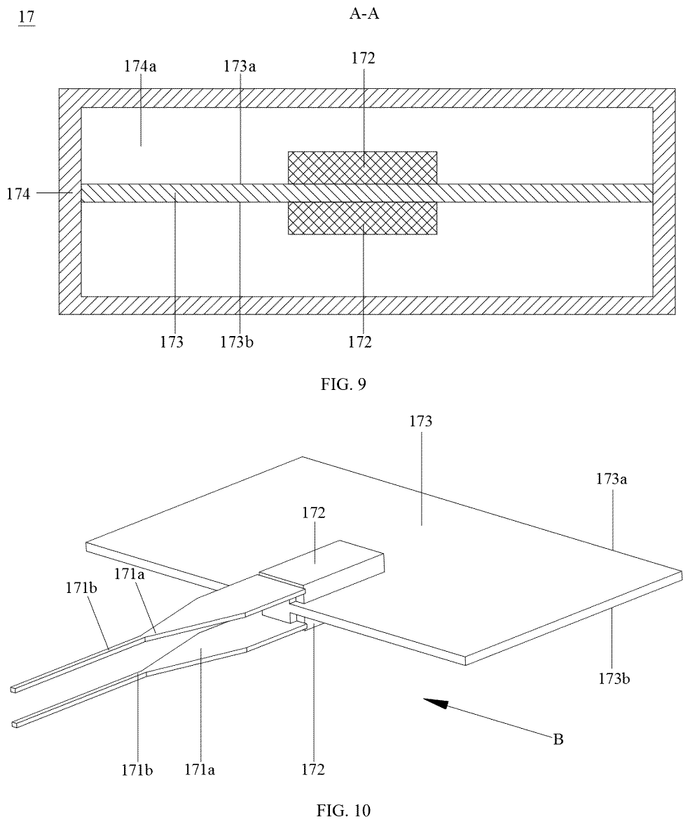

FIG. 8 shows internal and external three-dimensional structures of a mode converter 17 in Implementation 1 of this embodiment, and FIG. 9 is an A-A sectional view of the mode converter 17 shown in FIG. 8. As shown in FIG. 8 and FIG. 9, the mode converter 17 may include a coupled strip line 171, a ridge 172, a conductive plate 173, a flat waveguide 174, a tapered waveguide 175, and a standard rectangular waveguide 176. The ridge 172, the conductive plate 173, the flat waveguide 174, the tapered waveguide 175, and the standard rectangular waveguide 176 may be made of, for example, metal materials.

As shown in FIG. 8, the flat waveguide 174, the tapered waveguide 175, and the standard rectangular waveguide 176 are sequentially connected. Both the flat waveguide 174 and the standard rectangular waveguide 176 are rectangular waveguides. The tapered waveguide 175 may be trapezoidal, an end that is of the tapered waveguide 175 and that is connected to the flat waveguide 174 may be relatively narrow, and an end that is of the tapered waveguide 175 and that is connected to the standard rectangular waveguide 176 may be relatively wide. The flat waveguide 174, the tapered waveguide 175, and the standard rectangular waveguide 176 form a structure having a cavity.

As shown in FIG. 8 and FIG. 9, the conductive plate 173 may be fastened in an inner cavity 174a of the flat waveguide 174, and may be close to one side (for example, a left side in FIG. 8) of the flat waveguide 174. There is a gap between a plate surface 173a (a normal line of the plate surface is in a thickness direction of the conductive plate 173, and this is also applicable below) of the conductive plate 173 and a cavity wall that is of the inner cavity 174a and that is opposite to the plate surface 173a, and there is a gap between a plate surface 173b of the conductive plate 173 and a cavity wall that is of the inner cavity 174a and that is opposite to the plate surface 173b. The conductive plate 173 has a relatively small thickness, and may be of a thin-plate structure.

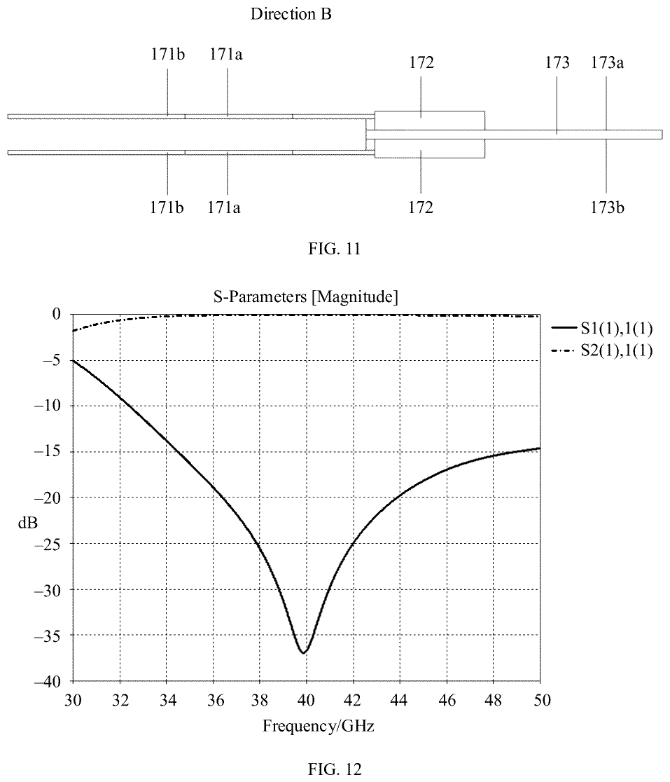

As shown in FIG. 10 and FIG. 11, there may be two ridges 172, and the two ridges 172 may be respectively fastened on the plate surface 173a and the plate surface 173b. The two ridges 172 may be close to an edge of the conductive plate 173. As shown in FIG. 9, the ridge 172 is not connected to a cavity wall of the inner cavity 174a, and there is a gap between the ridge 172 and the cavity wall of the inner cavity 174a. For example, an appearance of the ridge 172 may be approximately a rectangular block.

As shown in FIG. 8, the coupled strip line 171 may include an outer conductor 171c and two inner conductors, and the outer conductor 171c surrounds an outer periphery of the inner conductor. As shown in FIG. 10 and FIG. 11, each inner conductor may include a first part 171a and a second part 171b, and the first part 171a is connected to the second part 171b and the ridge 172. With reference to FIG. 8 and FIG. 3, an end that is of the second part 171b and that faces away from the first part 171a may be connected to the slow-wave line 142.

As shown in FIG. 10, the first part 171a may have a varying width, and the width of the first part 171a may decline from the ridge 172 to the second part 171b. “Declining” may include progressively decreasing; or may include an overall decreasing trend of the width, but there may be repetitions in some parts. For example, the first part 171a may include an equal-width part and a gradient-width part (the latter case); or the first part 171a may have only a gradient-width part but have no an equal-width part (the former case). The second part 171b may have, for example, a uniform width, and the width of the second part 171b is less than the width of the first part 171a.

In the mode converter 17 in Implementation 1, second parts 171b of the two inner conductors in the coupled strip line 171 may be respectively connected to the two layers of slow-wave lines 142, and the standard rectangular waveguide 176 may be connected to an external circuit. Therefore, the mode converter 17 connects the slow-wave line 142 to the external circuit, to implement mutual conversion between operating modes of the slow-wave line 142 and the external circuit.

For example, if the mode converter 17 is used in the input apparatus 12, the coupled strip line 171 is the input line 121. The standard rectangular waveguide 176, the tapered waveguide 175, the flat waveguide 174, the conductive plate 173, and the ridge 172 are all configured to perform mode conversion, to convert a standard waveguide mode of an external signal into the operating mode (for example, a TEM mode or a quasi-TEM mode) of the slow-wave structure 14. The structure design of the coupled strip line 171 makes the coupled strip line 171 have an impedance matching role. Therefore, the mode converter 17 can implement mode conversion, and input a converted to-be-amplified signal to the slow-wave line 142.

Alternatively, for example, if the mode converter 17 may be used in the output apparatus 16, the coupled strip line 171 is the output line 161. The ridge 172, the conductive plate 173, the flat waveguide 174, the tapered waveguide 175, and the standard rectangular waveguide 176 are all configured to perform mode conversion, to convert the operating mode (for example, a TEM mode or a quasi-TEM mode) of the slow-wave structure 14 into a standard waveguide mode of an external signal. The structure design of the coupled strip line 171 makes the coupled strip line 171 have an impedance matching role. Therefore, the mode converter 17 can implement mode conversion, and output a converted amplified signal to an external circuit.

FIG. 12 shows a simulation result of transmission performance of the traveling-wave tube 1 with the mode converter 17 used. As shown in FIG. 12, in a frequency range of 34 GHz to 42 GHz, a reflection coefficient S11 is less than −15 dB, and a transmission coefficient S21 is about −0.3 dB. This indicates that a transmission characteristic of the traveling-wave tube 1 is relatively good.

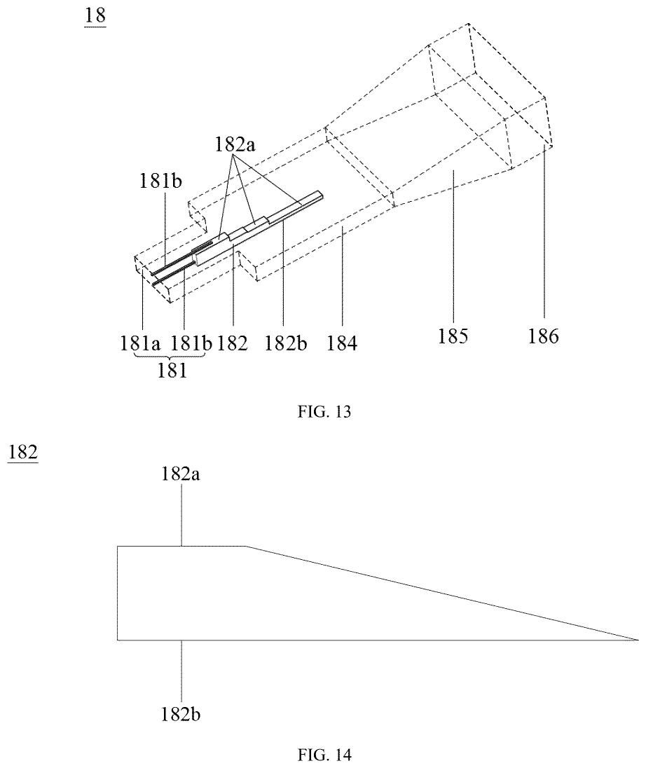

FIG. 13 shows internal and external three-dimensional structures of a mode converter 18 in Implementation 2 of this embodiment. As shown in FIG. 13, the mode converter 18 may include a coupled strip line 181, a ridge 182, a flat waveguide 184, a tapered waveguide 185, and a standard rectangular waveguide 186. The ridge 182, the flat waveguide 184, the tapered waveguide 185, and the standard rectangular waveguide 186 may be made of, for example, metal materials. It is learned, by comparing FIG. 13 and FIG. 12, that differences from the mode converter 17 are as follows: The mode converter 18 has no conductive plate; there is one ridge 182, and the ridge 182 may have a step structure; and an inner conductor 181b of the coupled strip line 181 may have a uniform width. The following provides descriptions.

As shown in FIG. 13, the ridge 182 may have a first surface 182a and a second surface 182b that are opposite to each other. The second surface 182b may be a flat surface, and the second surface 182b may be connected to an inner wall of an inner cavity of the flat waveguide 184. For example, the first surface 182a may have a step structure, and the step structure may include several sequentially connected steps (FIG. 13 shows four steps). For example, from an end that is of the ridge 182 and that is close to the tapered waveguide 185 to an end that is of the ridge 182 and that is away from the tapered waveguide 185 (for example, from a right end to a left end), these steps may sequentially rise, in other words, heights of the steps may sequentially increase, so that a spacing between the first surface 182a and the second surface 182b may rise. The first surface 182a is not connected to but has a gap with the inner wall of the inner cavity of the flat waveguide 184.

FIG. 14 shows a side view structure of a ridge 182 in another implementation. Different from that shown in FIG. 13, a first surface 182a of the ridge 182 shown in FIG. 14 does not form a step structure, but may include a flat surface and an inclined surface, so that a spacing between the first surface 182a and a second surface 182b can decline (from left to right). With reference to FIG. 14 and FIG. 13, the left end of the ridge 182 may be connected to the inner conductor 181b, and the right end of the ridge 182 may be close to the tapered waveguide 185.

Based on FIG. 14, in another implementation, all of a first surface 182a of a ridge 182 may be an inclined surface, so that a spacing between the first surface 182a and a second surface 182b can also decline. In the ridge 182, an end with a large spacing may be connected to the inner conductor 181b, and an end with a small spacing may be close to the tapered waveguide 185.

In the foregoing implementations, the spacing between the first surface 182a and the second surface 182b of the ridge 182 is made varying, so that the ridge 182 can also have an impedance matching role. When there are a relatively large quantity of spacing levels, relatively good impedance matching can be implemented. For example, as shown in FIG. 13, the step structure may have four steps, corresponding to three spacing levels (or height levels), so that the ridge 182 can have relatively good impedance matching performance.

As shown in FIG. 13, the coupled strip line 181 includes an outer conductor 181a and two inner conductors 181b, and the two inner conductors 181b may have uniform widths. The two inner conductors 181b may be connected to the end with the large spacing between the first surface 182a and the second surface 182b.

The mode converter 18 can also implement conversion between a standard waveguide mode of an external signal and the operating mode of the slow-wave structure 14.

Based on the foregoing implementations, a mode converter of another structure may be designed. For example, the tapered waveguide and the standard rectangular waveguide may be canceled, and the flat waveguide 184 is connected to an external circuit, so that conversion between a non-standard waveguide mode of an external signal and the operating mode of the slow-wave structure 14 can be implemented. In this solution, a difference from the foregoing is that the end with the small spacing between the first surface and the second surface of the ridge may be connected to the inner conductor.

In this embodiment, the traveling-wave tube 1 having the two layers of folding lines has a relatively strong electromagnetic wave field, a relatively strong interaction, relatively high efficiency, and a relatively high gain. In another embodiment, the traveling-wave tube may alternatively be disposed as having a single-layer folding line, and correspondingly, there is only one layer of support portions.

In the solution of this embodiment, the tube housing 141, the slow-wave line 142, and the support portion 143 in the slow-wave structure 14 are made into an integrated structure, so that processing and assembly errors caused by a split design of a conventional slow-wave structure can be improved, and an entire tube assembly process can be simplified, thereby shortening an overall production cycle of the traveling-wave tube, and improving a yield and consistency of the traveling-wave tube.

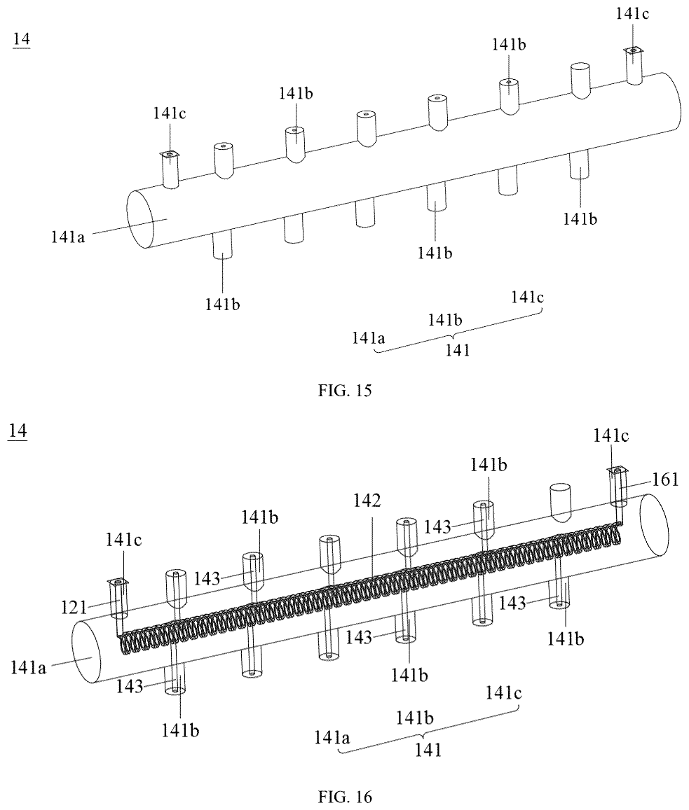

FIG. 15 and FIG. 16 are diagrams of structures of a slow-wave structure 14 in Embodiment 2. FIG. 15 is a diagram of an external structure of the slow-wave structure 14, and FIG. 16 is a diagram of internal and external structures of the slow-wave structure 14.

Different from that in Embodiment 1, a slow-wave line 142 of the slow-wave structure 14 shown in FIG. 15 and FIG. 16 is of a circular helical structure, and a cross section of the circular helical structure may be approximately circular. For example, a tube housing body 141a may be cylindrical, and a tube housing protruding portion 141b and a tube housing protruding portion 141c may also be cylindrical. A support portion 143 may be in a shape of a round rod. In Embodiment 2, the input apparatus may include a coaxial coupler and/or the output apparatus may include a coaxial coupler. The coaxial coupler is a mode converter, and is configured to implement conversion between an operating mode of an external circuit and an operating mode of the slow-wave structure 14.

A helix is disposed inside the slow-wave structure 14 in Embodiment 2, so that a specific product requirement can be met.

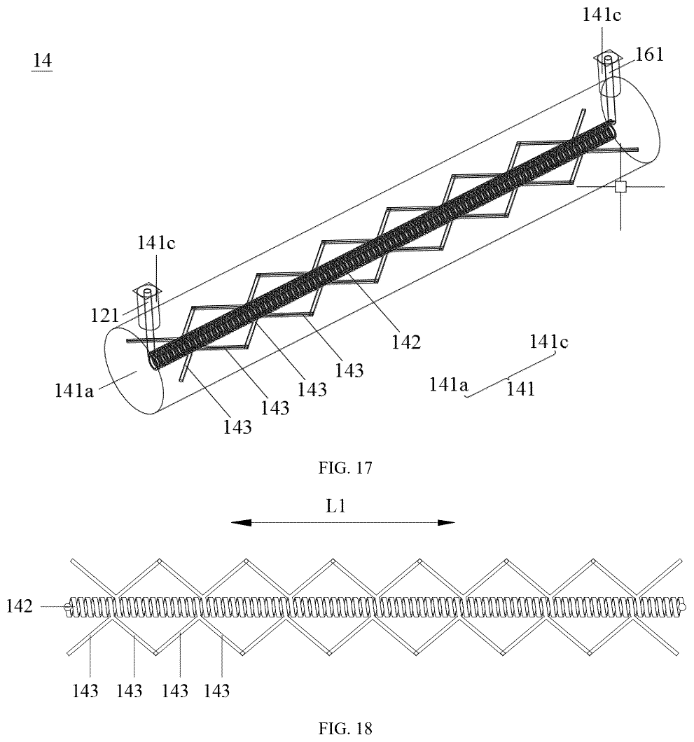

FIG. 17 and FIG. 18 are diagrams of structures of a slow-wave structure 14 in Embodiment 3. FIG. 17 is a diagram of internal and external structures of the slow-wave structure 14, and FIG. 18 is a diagram of structures of a slow-wave line 142 and a support portion 143 in the slow-wave structure 14.

Different from that in Embodiment 2, in a solution of Embodiment 3, a tube housing 141 may have no tube housing protruding portion configured to accommodate the support portion 143, and a volume of the tube housing 141 may be relatively small. In addition, each support portion 143 may be inclined relative to the slow-wave line 142, in other words, a non-90-degree included angle may be formed between a lengthwise direction of each support portion 143 and a lengthwise direction L1 of the slow-wave line 142. A plurality of support portions 143 located on each side of the slow-wave line 142 may be sequentially connected end to end and form a continuous wavy-line structure. For example, included angles formed between any two adjacent support portions 143 and the lengthwise direction L1 may be complementary, two support portions 143 spaced apart may be parallel, and included angles between every two support portions 143 may be equal. Certainly, the foregoing relative positions are merely examples, and are not limited in the solution of Embodiment 3.

In the solution of Embodiment 3, in a scenario in which a size of the tube housing 141 is limited, the support portion 143 is inclined, so that the support portion 143 is relatively long, thereby meeting a length requirement of the support portion 143. In addition, the support portions 143 are connected, to help increase support strength.

Based on the solution of Embodiment 3, another alternative solution may be obtained.

For example, in an embodiment, non-90-degree included angles may be formed between lengthwise directions of all support portions 143 and a lengthwise direction L1, all the support portions 143 are approximately parallel, and all the support portions 143 are not connected to each other.

Alternatively, in another embodiment, non-90-degree included angles may be formed between lengthwise directions of all support portions 143 and a lengthwise direction L1; one part of the support portions 143 are not connected to each other, for example, adjacent support portions 143 are not connected and are approximately parallel, or adjacent support portions 143 are not connected and extension lines of the adjacent support portions 143 intersect; and the other part of the support portions 143 may be sequentially connected to form a wavy-line structure.

Alternatively, in another embodiment, lengthwise directions of some support portions 143 may be perpendicular or approximately perpendicular to a lengthwise direction L1, and these support portions 143 are not connected to each other; and non-90-degree included angles may be formed between lengthwise directions of the other support portions 143 and the lengthwise direction L1, where all the support portions 143 may be sequentially connected to form a continuous wavy-line structure; or one part of the support portions 143 may be sequentially connected to form a continuous wavy-line structure, and the other part of the support portions 143 are not connected to each other, for example, adjacent support portions 143 are not connected and are approximately parallel, or adjacent support portions 143 are not connected and extension lines of the adjacent support portions 143 intersect.

It may be understood that, in embodiments of this application, in both the solutions in which the support portion 143 is perpendicular to and inclined to the slow-wave line 142, the tube housing protruding portion 141b may be disposed inside the tube housing 141 based on a product requirement, to accommodate the support portion 143, or the tube housing protruding portion 141b may not be disposed.

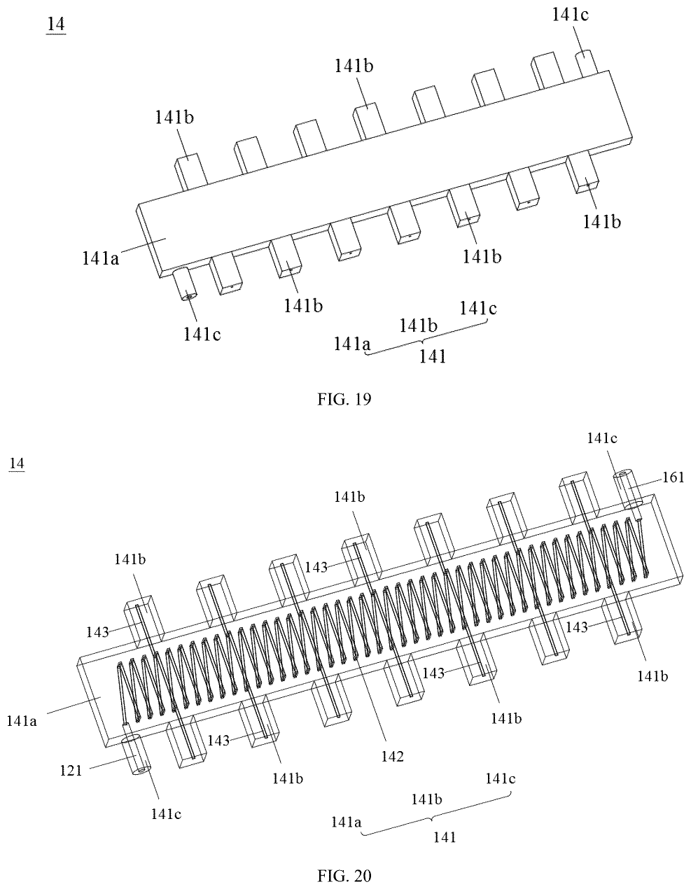

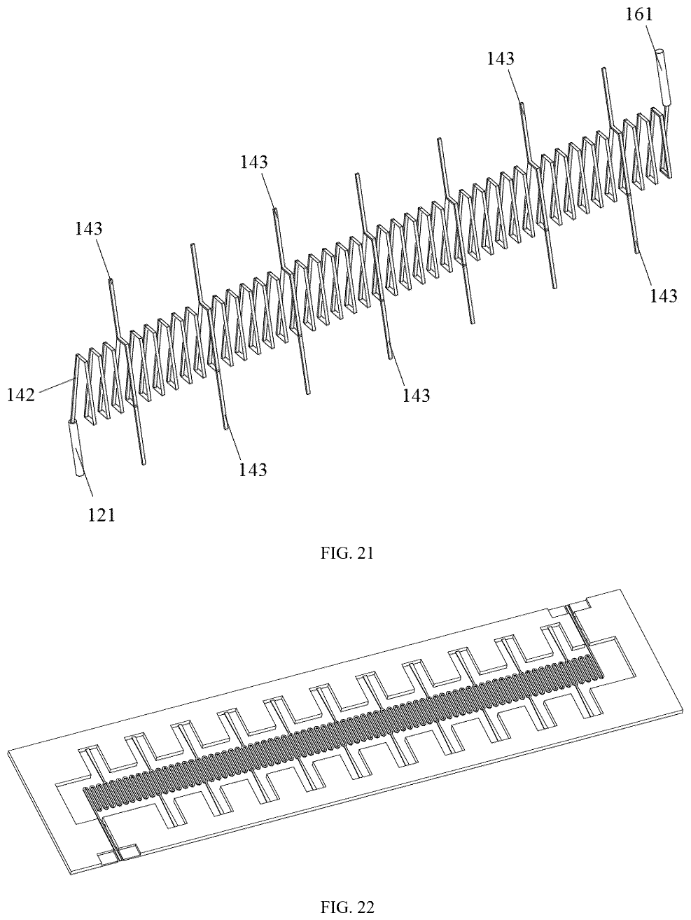

FIG. 19 and FIG. 20 are diagrams of structures of a slow-wave structure 14 in Embodiment 4. FIG. 19 is a diagram of an external structure of the slow-wave structure 14, and FIG. 20 is a diagram of internal and external structures of the slow-wave structure 14. FIG. 21 is a diagram of structures of a slow-wave line 142 and a support portion 143 of the slow-wave structure 14 in Embodiment 4.

Different from that in Embodiment 1, the slow-wave line 142 of the slow-wave structure 14 shown in FIG. 20 and FIG. 21 is of a rectangular helical structure, and a cross section of the rectangular helical structure may be approximately rectangular. The slow-wave line 142 of the rectangular helical structure is suitable for a strip-shaped electron beam (alternatively referred to as a square electron beam) to pass through. For example, a tube housing body 141a may be in a shape of a rectangular box, a tube housing protruding portion 141b may be in a shape of a rectangular box, and a tube housing protruding portion 141c may be cylindrical. The support portion 143 may be in a shape of a square rod. In Embodiment 4, the input apparatus may include a coaxial coupler and/or the output apparatus may include a coaxial coupler. The coaxial coupler is a mode converter, and is configured to implement conversion between an operating mode of an external circuit and an operating mode of the slow-wave structure 14.

The foregoing describes in detail a structure of the slow-wave structure 14 in embodiments of this application. The following describes a method for manufacturing the slow-wave structure 14 by using the planarization process.

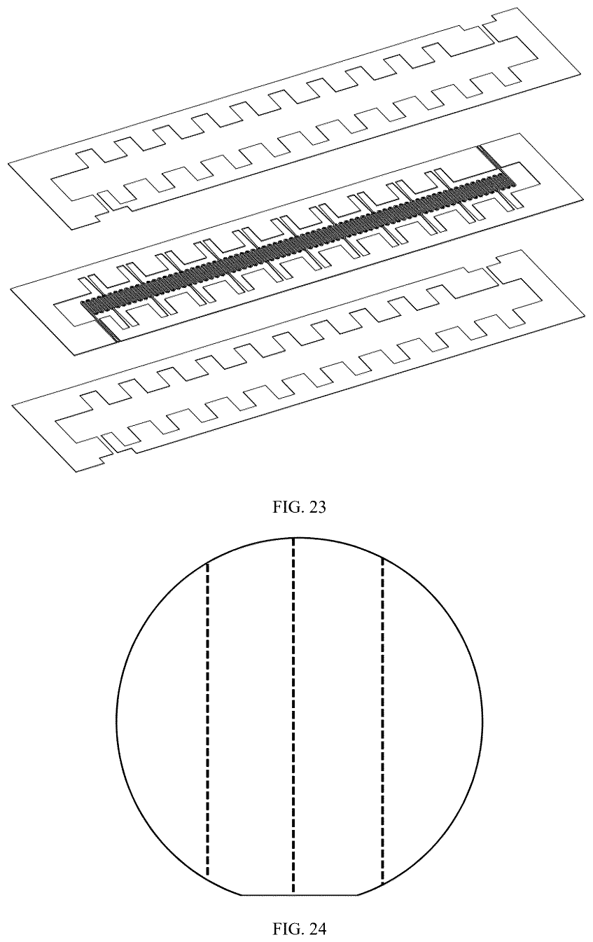

Embodiment 5 provides a method for manufacturing a slow-wave structure. The method may be used to manufacture the slow-wave structure 14 in any one of the foregoing embodiments. The manufacturing method may include the following steps.
S1. Provide a process file of a slow-wave structure, where the process file may include a typographic design file and a layout design file of the slow-wave structure. The typographic design file may include a three-dimensional model file (a three-dimensional model established by using modeling software) and a layered slice file (layered slice data obtained by processing the three-dimensional model file by using layered slice software) of the slow-wave structure. FIG. 22 is a schematic typographic of the slow-wave structure, and FIG. 23 shows a schematic layered slice of the slow-wave structure. The layout design file may include information about arranging a plurality of slow-wave units on a substrate. FIG. 24 shows region allocation on the substrate. Several slow-wave structures are subsequently arranged in each region. The process file is used to perform layered manufacturing on the substrate, and manufacture as many slow-wave structures as possible at one time in a limited substrate size.
S2. Sequentially deposit materials in layers based on the process file, to form a slow-wave structure array.

In an implementation, the materials may be sequentially deposited on the substrate in layers by using a semiconductor process, to form the slow-wave structure array.

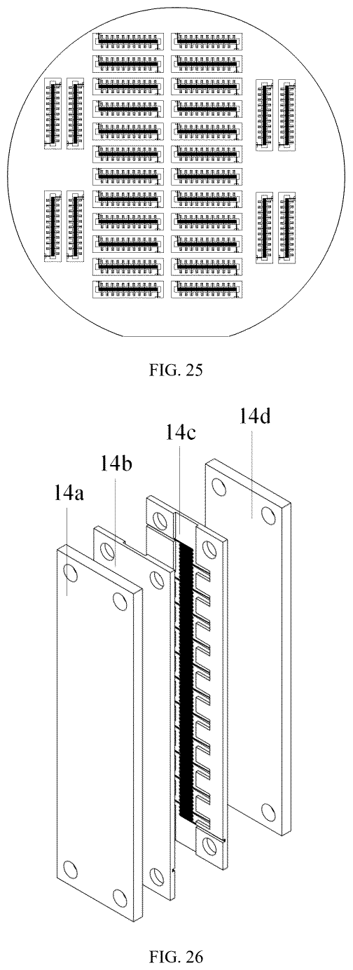

In a solution, the substrate may be, for example, a metal substrate such as a copper wafer. Surface polishing and cleaning processing may be first performed on the copper wafer, so that the copper wafer has relatively good flatness and as high smoothness as possible. This helps improve manufacturing precision and consistency of batch manufacturing, and can also reduce a loss of the slow-wave structure. Then, the copper wafer may be sequentially electroplated in layers based on the process file, to sequentially grow layers of materials. In this process, a hollow position in the slow-wave structure needs to be filled with a sacrificial layer (alternatively referred to as a mask), to support an electroplated material. After the electroplating is completed, the sacrificial layer may be removed by using a corrosion solution, all electroplated materials may be retained, and residues on surfaces of the electroplated materials may be cleaned. In this solution, the copper wafer may be used as a part of a tube housing of the slow-wave structure. FIG. 25 is a diagram of a slow-wave structure array electroplated on the copper wafer.

In another solution, the substrate may be, for example, a sapphire, and smoothness and flatness of a surface of the sapphire are relatively good. The sapphire substrate is separable from a slow-wave structure array on the sapphire substrate, so that the sapphire substrate can be stripped after batch manufacturing is completed, to facilitate reuse of the sapphire substrate.

In another implementation, the materials may be sequentially deposited on the substrate in layers by using a 3D printing process, to form the slow-wave structure array. The substrate is separable from the slow-wave structure array on the substrate, so that the substrate can be stripped after batch manufacturing is completed.

In another implementation, the slow-wave structure array may alternatively be formed by using another proper planarization process, for example, electroforming.
S3. Cut the slow-wave structure array into a plurality of independent slow-wave structures. For a solution in which the substrate needs to be stripped, the substrate may be removed before cutting. For a solution in which the substrate does not need to be stripped, the substrate and the slow-wave structure array on the substrate may be cut together.

In this embodiment, based on an actual case, a tube housing having a complete thickness may be formed by using a planarization process. Alternatively, if only a tube housing having a partial thickness can be formed due to a limitation of a planarization process, a peripheral tube housing may be separately manufactured, and the peripheral tube housing may be assembled with a tube housing that is of the slow-wave structure and that is manufactured by using the planarization process, to obtain the tube housing having the complete thickness. The peripheral tube housing and the tube housing manufactured by using the planarization process may also be referred to as sub tube housings. For example, as shown in FIG. 26, a slow-wave structure unit 14b and a slow-wave structure unit 14c that are manufactured by using a planarization process may be assembled into a slow-wave structure having two layers of folding lines. A tube housing of the slow-wave structure is further assembled with a peripheral tube housing 14a and a peripheral tube housing 14d.

In this embodiment, the foregoing mode converter may be further manufactured together with the slow-wave structure by using the planarization process. The process file may include a typographic design file and a layout design file of the slow-wave structure+mode converter. A slow-wave structure+mode converter array may be formed on the substrate by using the foregoing planarization process. The slow-wave structure+mode converter array may be cut, to prepare a plurality of independent slow-wave structures+mode converters, and each slow-wave structure+mode converter are integrally connected. It may be understood that, alternatively, the mode converter and the slow-wave structure may be separately manufactured and then assembled, and the mode converter and the slow-wave structure are not integrally connected.

After the slow-wave structure is manufactured, the slow-wave structure may be connected to an input apparatus, an output apparatus, a focusing system, an electron gun, a collector, and the like, to manufacture a traveling-wave tube. A manner of the connection may be, for example, welding, including but not limited to soldering and brazing, laser welding, argon shielded arc welding, or molecular diffusion welding.

In this embodiment of this application, the slow-wave structure is used as a circuit for exchanging energy between an electron beam and an electromagnetic wave of a vacuum electronic device, and a slow-wave line in the slow-wave structure is a transmission line having a reactance characteristic (the transmission line may have a periodic structure or an aperiodic structure). The transmission line having the reactance characteristic usually has a band-pass characteristic. Therefore, the slow-wave structure can also be used as a filter, in other words, the filter can include the foregoing tube housing, slow-wave line, and support portion. The filter may be a band-pass filter, and allows a signal of a specific frequency or band to pass through, and does not allow a signal of another frequency to pass through. The filter may alternatively be a low-pass filter. The filter may be used in any type of communication system, radar test system, or measurement system.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

1. A slow-wave structure,
comprising a tube housing, a slow-wave line, and a plurality of support portions, wherein the slow-wave line and the plurality of support portions are all located inside the tube housing, and the tube housing, the slow-wave line, and the plurality of support portions are integrally connected; the plurality of support portions are sequentially spaced apart along the slow-wave line; and one end of each support portion is connected to the tube housing, and the other end is connected to the slow-wave line.

2. The slow-wave structure according to claim 1, wherein
the tube housing comprises a tube housing body and a plurality of tube housing protruding portions, the plurality of tube housing protruding portions are all connected to the tube housing body, the plurality of tube housing protruding portions project from the tube housing body, and the plurality of tube housing protruding portions are sequentially spaced apart along the tube housing body; and
the slow-wave line is located inside the tube housing body; and one part of each support portion is accommodated in the tube housing body, and the other part of each support portion is accommodated in the tube housing protruding portion.

3. The slow-wave structure according to claim 1, wherein
a lengthwise direction of at least one support portion is perpendicular to a lengthwise direction of the slow-wave line.

4. The slow-wave structure according to claim 1, wherein
a non-90-degree included angle is formed between a lengthwise direction of at least one support portion and a lengthwise direction of the slow-wave line.

5. The slow-wave structure according to claim 4, wherein
at least a part of the plurality of support portions are sequentially connected to form a wavy-line structure.

6. The slow-wave structure according to claim 1, wherein
the plurality of support portions are distributed on two sides of the slow-wave line.

7. The slow-wave structure according to claim 1, wherein
a length L of each support portion and a guided-wave wavelength λ of the slow-wave structure satisfy the following relationship formula:
$$L = \frac{n λ}{4} * ( 1 \pm 10 \% ) ,$$
wherein n is an odd number.

8. The slow-wave structure according to claim 1, wherein
the tube housing, the slow-wave line, and the plurality of support portions are made of a same material.

9. The slow-wave structure according to claim 1, wherein
each support portion comprises an inner layer and an outer layer, the outer layer is wrapped around an outer periphery of the inner layer, the inner layer is made of an insulating material, and the outer layer is made of a same material as the tube housing and the slow-wave line.

10. The slow-wave structure according to claim 1, wherein
the slow-wave structure further comprises an attenuator, the slow-wave line comprises a plurality of disconnected segments, and each of the plurality of segments is connected to the attenuator.

11. The slow-wave structure according to claim 1, wherein
the slow-wave line is a folding line, the folding line comprises a plurality of bending units sequentially connected end to end, and all the bending units are coplanar.

12. The slow-wave structure according to claim 11, wherein
the plurality of support portions are coplanar with the slow-wave line.

13. The slow-wave structure according to claim 11, wherein
the slow-wave structure comprises two layers of support portions between which a gap is defined, and each layer of support portions comprises a plurality of support portions; and the slow-wave structure comprises two layers of slow-wave lines between which a gap is defined, and one layer of slow-wave line is correspondingly connected to one layer of support portions.

14. The slow-wave structure according to claim 1, wherein
the slow-wave line has a helical structure.

15. A traveling-wave tube,
comprising an electron gun, a focusing system, a collector, an input apparatus, an output apparatus, and a slow-wave structure
wherein the slow-wave structure comprises a tube housing, a slow-wave line, and a plurality of support portions, wherein the slow-wave line and the plurality of support portions are all located inside the tube housing, and the tube housing, the slow-wave line, and the plurality of support portions are integrally connected; the plurality of support portions are sequentially spaced apart along the slow-wave line; and one end of each support portion is connected to the tube housing, and the other end is connected to the slow-wave line;
wherein the electron gun, the focusing system, the collector, the input apparatus, and the output apparatus are all connected to the slow-wave structure.

16. The traveling-wave tube according to claim 15, wherein
the input apparatus comprises a mode converter and/or the output apparatus comprises a mode converter, the mode converter is connected to the slow-wave line, and the mode converter is configured to implement conversion between an operating mode of the slow-wave structure and an operating mode of an external circuit.

17. The traveling-wave tube according to claim 16, wherein
the slow-wave structure comprises two layers of slow-wave lines; and
the mode converter comprises a flat waveguide, a conductive plate, a ridge, and a coupled strip line; the conductive plate is disposed inside an inner cavity of the flat waveguide, and there is a gap between each of plate surfaces on two opposite sides of the conductive plate and a cavity wall of the inner cavity; the ridge is disposed on the plate surface, and the ridge is not connected to the cavity wall of the inner cavity; an inner conductor of the coupled strip line comprises a first part and a second part, the first part is connected to the ridge and the second part, and an end that is of the second part and that faces away from the first part is connected to the two layers of slow-wave lines; and a width of the first part is greater than a width of the second part, and the width of the first part declines along a direction from the first part to the second part.

18. The traveling-wave tube according to claim 16, wherein
the slow-wave structure comprises two layers of slow-wave lines; and
the mode converter comprises a flat waveguide, a ridge, and a coupled strip line; the ridge is disposed inside an inner cavity of the flat waveguide, the ridge comprises a first surface and a second surface, the first surface is opposite to the second surface, a spacing between the first surface and the second surface declines from one end of the ridge to the other opposite end, there is a gap between the first surface and an inner wall of the inner cavity, and the second surface is connected to the inner wall of the inner cavity; and an inner conductor of the coupled strip line is connected to the ridge and the two layers of slow-wave lines.

19. The traveling-wave tube according to claim 18, wherein
the first surface has a plurality of sequentially connected steps, and heights of the plurality of steps sequentially decrease.

20. The traveling-wave tube according to claim 17, wherein
the mode converter comprises a tapered waveguide and a standard rectangular waveguide, the tapered waveguide is connected to the flat waveguide and the standard rectangular waveguide, and the coupled strip line and the standard rectangular waveguide are respectively located at two opposite ends of the flat waveguide.
